(19) United States
(12) Patent Application Publication
(10) Pub. No.: US 2026/0135763 A1
(43) Pub. Date: May 14, 2026

(54) SMART-TOR POLICY ORCHESTRATION BASED ON NCCL TOPOLOGY

(71) Applicant: Cisco Technology, Inc., San Jose, CA (US)

(72) Inventors: Clarence Andre M. Filsfils, Uccle (BE); Pablo Camarillo Garvia, Madrid (ES); Ahmed Mohamed Ahmed Abdelsalam, L’Aquila (IT); Bruce McDougall, Anacortes, WA (US); Carmine Scarpitta, Santa Marina (IT)

(73) Assignee: Cisco Technology, Inc., San Jose, CA (US)

(21) Appl. No.: 19/385,285

(22) Filed: Nov. 11, 2025

Related U.S. Application Data
(60) Provisional application No. 63/718,966, filed on Nov. 11, 2024.
(60) Provisional application No. 63/730,395, filed on Dec. 10, 2024.
(60) Provisional application No. 63/777,233, filed on Mar. 25, 2025.
(60) Provisional application No. 63/777,244, filed on Mar. 25, 2025.

(51) Int. Cl. H04L 41/0894; H04L 41/12; H04L 43/04; H04L 47/125

(52) U.S. Cl. CPC H04L 41/0894; H04L 41/12; H04L 43/04; H04L 47/125

(57) ABSTRACT

In some implementations, a device obtains topology information regarding communication pathways available between graphics processing units (GPUs) in a network. The device also obtains, via an NVIDIA Collective Communications Library (NCCL) application programming interface (API), data indicative of a communication graph of communications between the graphics processing units during one or more scheduled jobs. The device computes, based on the communication graph and the topology information, a network policy for the network that controls over which path a particular communication is sent between a pair of GPUs. The device implements enforcement of the network policy in the network.

### RELATED APPLICATIONS

The present disclosure claims priority to U.S. Prov. Appl. Ser. No. 63/718,966, filed on Nov. 11, 2024, entitled “OPTIMIZING LLM TRAINING CLUSTER EFFICIENCY WITH A SOURCE-ROUTED BACKEND,” by Garvia, et al., to U.S. Prov. Appl. Ser. No. 63/730,395, filed on Dec. 10, 2024, entitled “NETWORK CONTROLLER MECHANISM FOR GPU-AWARE NETWORK ORCHESTRATOR,” by Garvia, et al., and to U.S. Prov. Appl. Ser. No. 63/777,233, filed on Mar. 25, 2025, entitled “SMART-TOR POLICY ORCHESTRATION BASED ON NCCL TOPOLOGY,” by Filsfils, et al., the contents of which are incorporated herein by reference.

### TECHNICAL FIELD

The present disclosure relates generally to network compute fabrics and, more particularly to smart top-of-rack (ToR) policy orchestration based on the NVIDIA Collective Communications Library (NCCL) topology.

### BACKGROUND

In modern artificial intelligence (AI) and high-performance computing (HPC), fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend graphics processing unit (GPU)-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

In large-scale AI training clusters and other high-performance computing (HPC) fabrics, data parallelism is a commonly adopted approach, allowing multiple GPUs to work in parallel on the same task across extensive datasets. This setup requires frequent synchronization of memory between GPUs, especially as training jobs may involve more than 15,000 iterations. After each iteration, GPUs must communicate and exchange data, resulting in periodic, bursty flows. However, in a bare metal offering, the cloud vendor does not control the hosts/GPUs from the end customers and there is no coordination between the cloud vendor and the end customers to improve the overall performance and reduction of the job completion time.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with an artificial intelligence (AI) model;

FIG. 4 illustrates an example architecture for an AI agent;

FIG. 5 illustrates an example network or compute fabric for performing AI model training and high-performance computing (HPC) tasks; and

FIG. 6 illustrates an example simplified procedure for smart top of rack (TOR) policy orchestration based on NVIDIA Collective Communications Library (NCCL) topology information.

### DESCRIPTION OF EXAMPLE IMPLEMENTATIONS

### Overview

According to one or more implementations of the disclosure, a device obtains topology information regarding communication pathways available between graphics processing units (GPUs) in a network. The device also obtains, via an NVIDIA Collective Communications Library (NCCL) application programming interface (API), data indicative of a communication graph of communications between the graphics processing units during one or more scheduled jobs. The device computes, based on the communication graph and the topology information, a network policy for the network that controls over which path a particular communication is sent between a pair of GPUs. The device implements enforcement of the network policy in the network.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

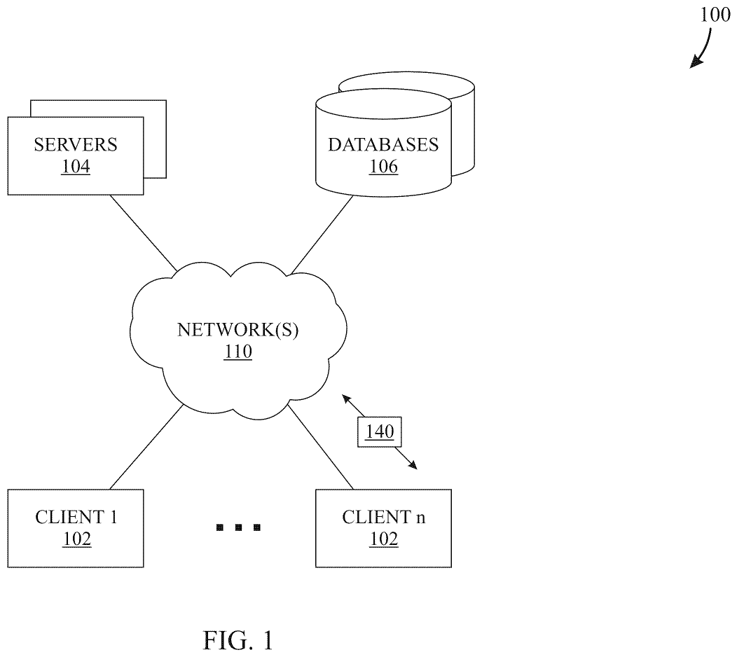

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

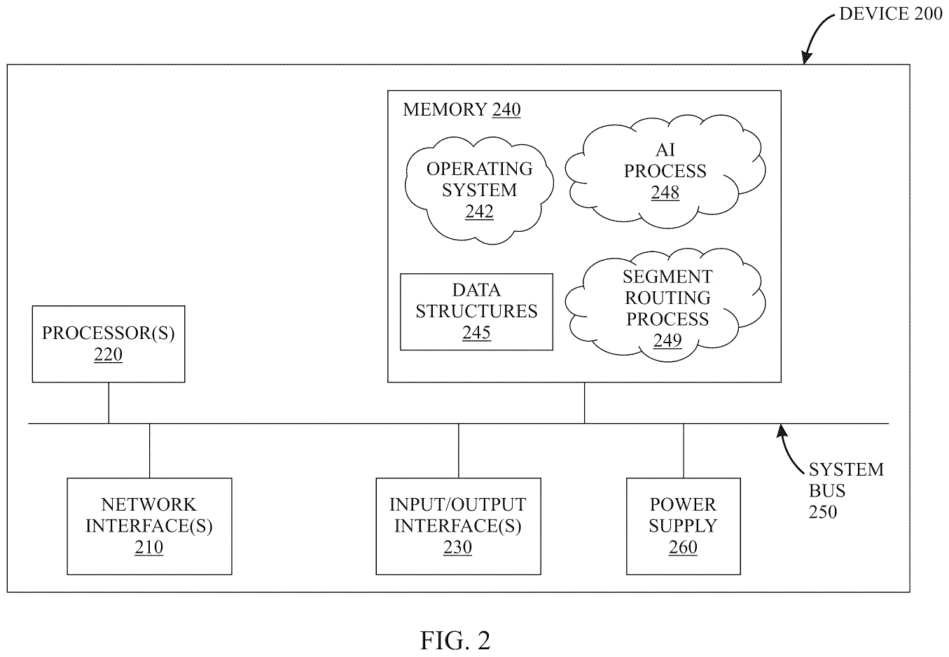

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248 and/or a segment routing process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

Segment routing process 249 includes computer executable instructions executed by processor 220 to perform functions in accordance with one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. For instance, these operations may include configuring and managing a forwarding information database containing, e.g., data used to make forwarding decisions. In particular, changes in the network topology may be communicated among devices in the computer network, such as device 200, using a routing protocol, such as the OSPF or IS-IS link-state protocols, to “converge” to an identical view of the network topology.

In various implementations, segment routing process 249 may cause device 200 to perform segment routing in the network, such as, e.g., in conjunction with Multiprotocol Label Switching (MPLS). For example, segment routing process 249 may utilize extensions to the IGP (e.g., IS-IS, OSPF, etc.), that allow IGP messages to carry MPLS label information, to use segment routing within the network.

In general, segments in a segment routed network may fall into one of two categories: node segments and adjacency segments. Adjacency segments generally represent the local interface between a given node and an adjacent neighbor. Notably, adjacency segments do not need to be unique among the different nodes, as adjacency segments only require local significance to the particular node. Node segments, in contrast, are global in nature and use unique identifiers to represent node segment endpoints. When used in conjunction with MPLS, segments (e.g., node and adjacency segments) may be treated as labels, whereby a node may either “push” a new segment/label onto the stack, “pop” (e.g., remove) the top segment/label from the stack, or “swap” the top label of the stack with another label.

In various implementations, as detailed further below, AI process 248 and/or segment routing process 249 may include computer executable instructions that, when executed by processor 220, cause device 200 to perform the techniques described herein. To do so, in some implementations, AI process 248 and/or segment routing process 249 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 and/or segment routing process 249 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that AI process 248 and/or segment routing process 249 could use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 and/or segment routing process 249 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

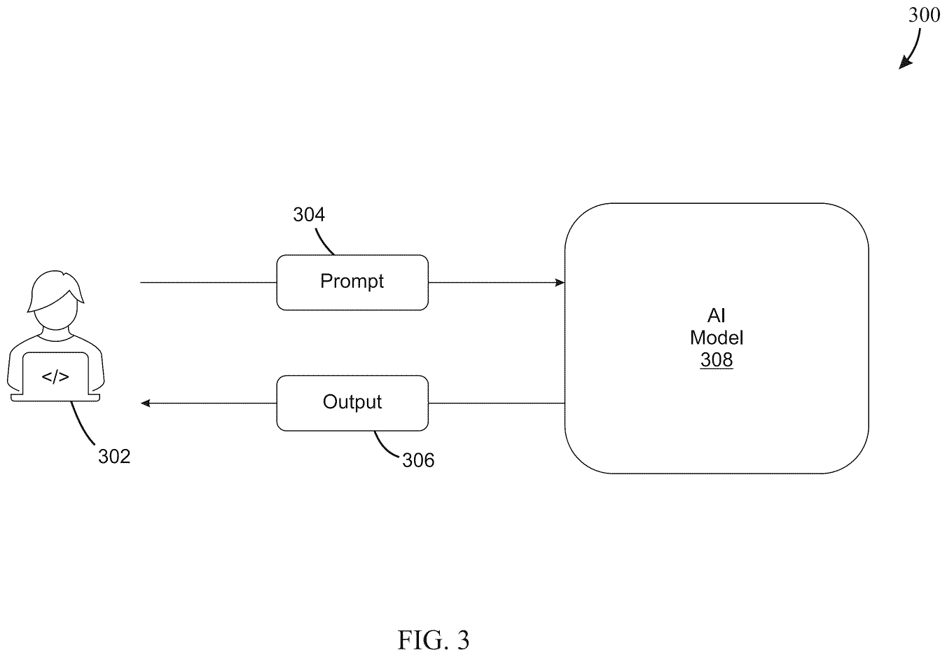

FIG. 3 illustrates an example 300 for interfacing with an AI model, in various implementations. In example 300, a user 302 may send a prompt 304 (e.g., a query, a query augmented with additional data, documents, and/or images, etc.) to an AI model 308. The AI model 308 may be configured to process a prompt 304 to generate an output 306 to satisfy the prompt 304.

AI model 308 may be a model configured to apply its trained algorithms to generate a response (e.g., output 306) based on the prompt 304 provided. More specifically, AI model 308 may be trained on a training dataset 310 and, once trained, be deployed for inference. For instance, in some cases, AI model 308 may take the form of a large language model (LLM) or other foundation model, diffusion-based model, combinations thereof, or the like.

The output 306 may be the result produced by AI model 308 (e.g., by the application of AI model 308 to the prompt 304). This output can vary depending on the model's configuration and the task at hand. For example, the output 306 may include one or more of a generated and/or synthesized image, a text response, a classification and/or prediction, etc.

As would be appreciated, AI agents are also capable of interacting with generative models, such as AI model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

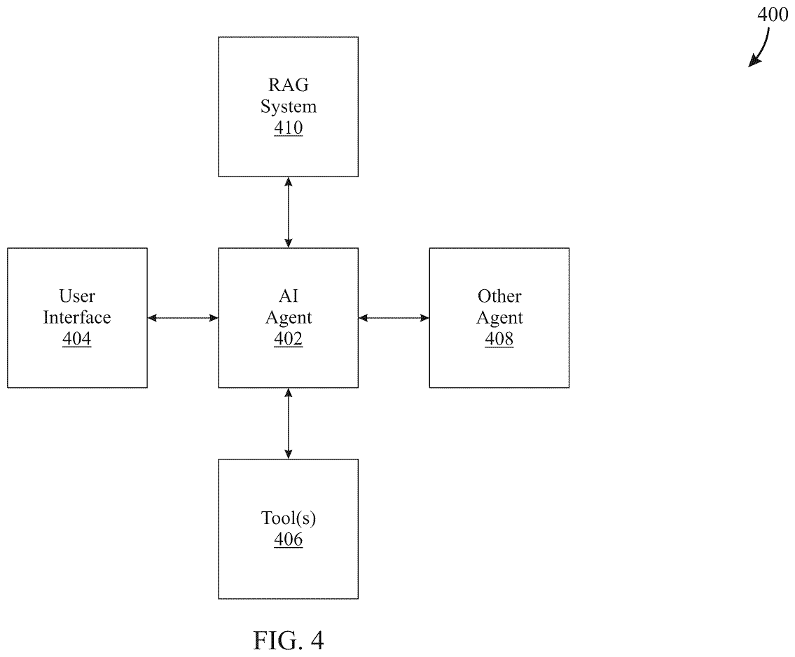

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

Indeed, LLMs and other modern AI models are capable of performing a wide variety of tasks. In addition, agentic systems may leverage such models to perform an even larger set of tasks. However, training an AI model and performing other high-performance computing (HPC) tasks is not straightforward, as network or compute fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend GPU-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

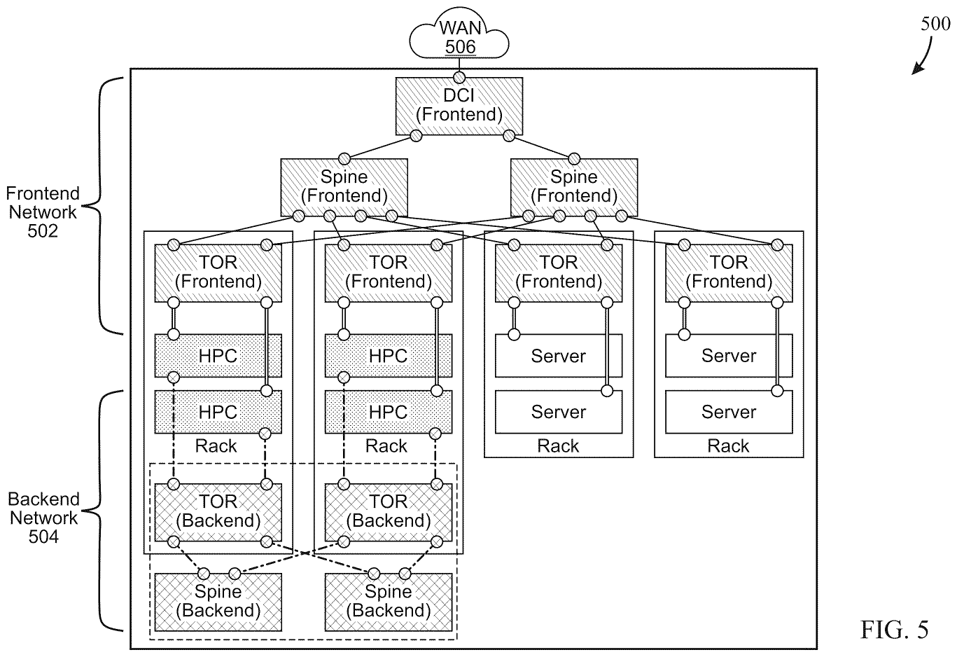

By way of example, FIG. 5 illustrates an example network or compute fabric 500 for performing AI model training and HPC tasks, according to various implementations. As shown, network or compute fabric 500 may include a frontend network 502 and a backend network 504. Network or compute fabric 500 may also be connected to a WAN 506, allowing for remote access.

For instance, frontend network 502 may include various components such as a data center interconnect (DCI), any number of frontend spines, a plurality of top-of-rack (TOR) switches, etc. Likewise, backend network 504 may include HPC clusters, servers, its own backend TOR switches, etc. on the racks, as well as its own backend spines. As would be appreciated, the specific configuration and components of frontend network 502 and backend network 504 may differ as desired.

As noted above, in large-scale AI training clusters and other high-performance computing (HPC) fabrics, such as in FIG. 5, data parallelism is a commonly adopted approach, allowing multiple GPUs to work in parallel on the same task across extensive datasets. This setup requires frequent synchronization of memory between GPUs, especially as training jobs may involve more than 15,000 iterations. After each iteration, GPUs must communicate and exchange data, resulting in periodic, bursty flows. However, in a bare metal offering, the cloud vendor does not control the hosts/GPUs from the end customers and there is no coordination between the cloud vendor and the end customers to improve the overall performance and reduction of the job completion time.

### Smart ToR Policy Orchestration Based on the NCCL Topology

The techniques herein introduce an application programming interface (API)-based approach to orchestrate policies on a smart top-of-rack (ToR) device.

Illustratively, the techniques described herein may be performed by hardware, software, and/or firmware, such through execution of segment routing process 249, which may include computer executable instructions executed by the processor 220 (or independent processor of interfaces 210) to perform functions relating to the techniques described herein, e.g., in conjunction with AI process 248.

Specifically, according to various implementations, a device obtains topology information regarding communication pathways available between graphics processing units (GPUs) in a network. The device also obtains, via an NVIDIA Collective Communications Library (NCCL) application programming interface (API), data indicative of a communication graph of communications between the graphics processing units during one or more scheduled jobs. The device computes, based on the communication graph and the topology information, a network policy for the network that controls over which path a particular communication is sent between a pair of GPUs. The device implements enforcement of the network policy in the network.

Operationally, in various implementations, the end customer, who has vested interest in achieving greater performance in their GPU cluster, may provide a read-only API to their NCCL topology to the cloud vendor.

Once the AI-job has been orchestrated, the cloud vendor in charge of the network fabric could execute the following:
Retrieve the NCCL topology from the end customer (GPU communication graph)
Compute segment routing (SR) policies that homogenize the link utilization overall for the entire fabric
Provision policies on the Leaves
At the Leaf:
Steer GPU traffic into an SR policy
Provision Internetwork Performance Monitor (IPM) measurement, or using another suitable monitoring mechanism, for each SR policy validating the uSID list
Provision a backup (non-used) SR Policy to be used in case of IPM switch-over

Such an approach could achieve near perfect network utilization. In addition, this approach has the added benefit that the underlay fabric can be shared by several customers, and the cloud vendor can optimize the network such that all customers receive better overall performance or even isolate determined resources in the underlay fabric for VIP Customers.

In various implementations, the workflow steps are as follows:

### Step 1: Retrieving the PCIe and NVLink Topology

The network controller retrieves the physical topology of the GPUs in the system. In some implementations, this information is retrieved from the NCCL topology, which provides details about PCIe and NVLink connectivity. In turn, the network controller may leverage the information to build two datasets:
dataset1: communication paths offloaded to NVLink
dataset2: communication paths that will use the AI backend network fabric.

### Step 2: Retrieving the GPU Communication Graph

Using the NCCL API, the techniques herein then monitor and track the collective operations scheduled during the AI job. This step involves subscribing to the NCCL API calls during job scheduling. The network controller leverages the collected data from the API calls to build a detailed communication graph, identifying which GPUs will communicate via the fabric and the expected traffic volume.

Importantly, this communication graph is highly stable throughout the duration of the AI job, which can span several weeks. This has been confirmed by several hyperscalers including Microsoft and Alibaba. AI training jobs, particularly those for large language models or other computationally intensive tasks, follow a fixed schedule of iterations and collective operations. Once initialized, the communication patterns between GPUs remain consistent unless there is a system-level interruption or a deliberate change in the job configuration.

This stability allows the proposed mechanism to rely on the precomputed graph to generate optimal network policies. By aligning the network configuration with this stable communication pattern, the solution ensures maximum efficiency. Any unexpected deviations during runtime (e.g., due to faults or unplanned communication patterns) are handled reactively in Step 5.

### Step 3: Policies Computation

The network controller may then compute a set of optimal network policies for the AI backend fabric. In various implementations, this may entail using an optimization algorithm that leverages the following:
1. The Two Datasets From Step 1:
   a. dataset1: communication paths offloaded to NVLink
   b. dataset2: communication paths that will use the AI backend network fabric.
2. The detailed communication graph from Step 2 above

In some implementations, the network controller may enforce these policies by expressing them as a set of static routes. In further implementations, though, it may do so by expressing them as source routing policies, as described further below.

### Step 4: Policies Configuration

The network controller may then download and install the computed policies onto the leaf devices.

### Step 5: Handling Runtime Changes

During the runtime of the AI job, the network controller continues to monitor traffic. In the NVIDIA GPU, this can be achieved using the LD_PRELOAD mechanism, which wraps NCCL functions to log ongoing communication patterns. If the observed traffic deviates from the pre-scheduled patterns, the network controller leverages the information to recalibration. This ensures that any unscheduled or unexpected communication is promptly optimized by adjusting the network policies in real-time.

### Optimized LLM Training Cluster Efficiency with a Source-Routed Backend

Another challenge in the context of AI and HPC fabrics stems from the fact that traditional load-balancing mechanisms struggle with the bursty, high-volume flows often seen in these types of fabrics. Hash-based load balancing, for instance, is particularly prone to issues like hash polarization whereby specific flows are repeatedly directed through the same network paths, leading to congestion. This congestion results in significant delays in job completion times, impacting overall training efficiency and scaling.

The limited queue pair (QP) (i.e., flows) capacity of network interface cards (NICs) also presents a further constraint in the context of AI and HPC fabrics. Indeed, studies have shown that NIC performance degrades when using more than a hundred QPs. This prevents breaking down these large flows into smaller, more manageable flows. As a result, the flow characteristics cannot be adjusted to reduce their impact on the network, necessitating a different approach to minimize congestion and polarization.

According to further aspects of the teachings herein, a promising approach to address the polarization and congestion challenges in AI training clusters is to build a deterministic, Source Routed AI Fabric. Generally, the solution introduced herein relies on segment routing (e.g., using SRv6) to steer traffic between GPUs, offering a scalable and open-standards-based method that enhances load distribution across network fabric links. This may be achieved, for example, through execution of segment routing process 249.

In various implementations, on job orchestration, each source-destination pair, denoted (SRC, DST), may be mapped to multiple, disjoint micro-segment identifier (uSID) lists. These uSID lists are precomputed with the specific objective of balancing traffic load across the network fabric by factoring in link utilization, using a weighted assignment that optimizes link usage and prevents congestion. In various implementations, this may be performed by executing segment routing process 249 at the data processing unit (DPU) of the rack (e.g., at its network interface card (NIC), or at the TOR.

In instances in which segment routing process 249 is executed at the TOR, it may proceed as follows:
Its scheduler, upon job orchestration, for each (SRC, DST) GPU pair computes multiple, disjoint uSID lists that are installed in both of the homing TORs of the NIC associated with that GPU.
The TOR receives a ROCEv2 packet of the form: Eth, IP(SRC, DST), UDP, BTH (QP_identifier).
The TOR steers all traffic for that (SRC, DST) into the set of uSID lists that were computed by the controller.
The specific SID list to be used is picked according to Equal-Cost Multi-Path (ECMP) hashing using as input parameters (IP_SRC, IP_DST, UDP_Ports, QP_id).
The routers along the fabric will steer according to the specific SID list.
If, either through the congestion mechanisms (ECN, DCQCN) or through the Integrated Performance Measurement (IPM) metrics, it is detected that that specific path is not performing well; then the uSID list is disabled and the trffic is repath to another disjoint uSID list. Note that the change from the old uSID list to the new uSID list can be done flowlet-based (i.e., waiting for an specific amount of time without traffic within the flow to avoid any mis-ordering), in some implementations.

In further implementations, when segment routing process 249 is hosted on the NIC, it may proceed as follows:
Its scheduler, upon job orchestration, computes for each (SRC, DST) multiple, disjoint uSID lists.
On the NIC, for each QP, two uSID lists are installed: a main and a backup one.
The NIC crafts the ROCEv2 packet and pushes an additional IPv6 header containing the uSID list of that QP.
The routers along the DC fabric will steer according to the specific SID list.
If, either through the congestion mechanisms (ECN, DCQN) or through the IPM measurements, it is detected that that specific path is not performing well; then the uSID list is disabled and switched to the backup one. The controller may decide to install a new uSID list on the NIC for the future.

This mechanism allows traffic associated with each QP to be evenly distributed across multiple, dynamically selected paths in the network fabric, effectively removing polarization without requiring proprietary solutions. By leveraging SRv6's capabilities, this solution provides a resilient, standardized method for managing high throughput, synchronized GPU communication in AI clusters, significantly improving overall job completion times and network efficiency.

Advantageously, this approach leverages open standards and is interoperable. In addition, it can be implemented on the NIC or TOR, as desired, adding flexibility to deployment options. Further, SID lists can be combined with IPM for health monitoring. This allows the fabric to adjust to path disruption while maintaining optimal load distribution.

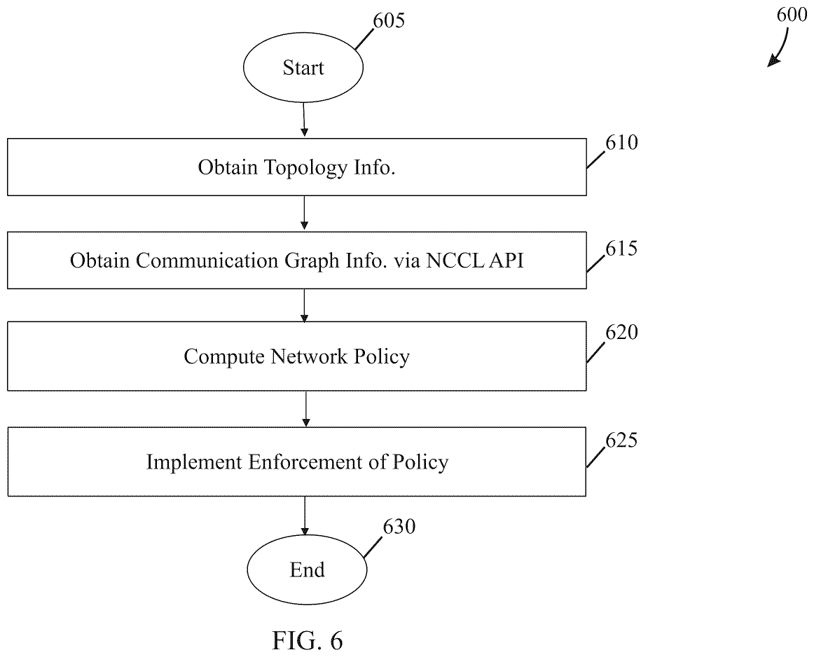

FIG. 6 illustrates an example simplified procedure for smart top of rack (TOR) policy orchestration based on NVIDIA Collective Communications Library (NCCL) topology information, in accordance with one or more implementations described herein. For example, a non-generic, specifically configured device (e.g., device 200), may perform procedure 600 (e.g., a method) by executing stored instructions (e.g., AI process 248 and/or segment routing process 249). The procedure 600 may start at step 605, and continues to step 610, where, as described in greater detail above, the device (e.g., a controller, server, etc.) may obtain topology information regarding communication pathways available between graphics processing units (GPUs) in a network. In some implementations, the topology information includes data indicative of communication pathways offloaded to NVLink. In further implementations, the topology information includes data indicative of communication pathways that use a backend network fabric.

At step 615, as detailed above, the device may also obtain, via an NVIDIA Collective Communications Library (NCCL) application programming interface (API), data indicative of a communication graph of communications between the graphics processing units during one or more scheduled jobs. In various implementations, the one or more scheduled jobs are training jobs for an artificial intelligence model.

At step 620, the device may compute, based on the communication graph and the topology information, a network policy for the network that controls over which path a particular communication is sent between a pair of GPUs, as described in greater detail above. In some implementations, the network policy uses segment routing to load balance traffic in the network between GPUs. In one implementation, the network policy comprises multiple, disjoint micro segment identifier (uSID) lists. In some cases, a top of rack (TOR) steers traffic between a particular pair of GPUs in the network using a uSID list associated with that particular pair of GPUs. In other cases, a network interface card (NIC) steers traffic between a particular pair of GPUs in the network using a uSID list associated with that particular pair of GPUs.

At step 625, as detailed above, the device may implement enforcement of the network policy in the network. In some instances, this may entail providing the network policy to one or more leaf nodes in the network. The device may also adjust the network policy based on real-time monitoring data regarding traffic in the network.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that allow for smart top-of-rack (ToR) policy orchestration based on the NVIDIA Collective Communications Library (NCCL) topology, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
obtaining, by a device, topology information regarding communication pathways available between graphics processing units (GPUs) in a network;
obtaining, by the device and via an NVIDIA Collective Communications Library (NCCL) application programming interface (API), data indicative of a communication graph of communications between the graphics processing units during one or more scheduled jobs;
computing, by the device and based on the communication graph and the topology information, a network policy for the network that controls over which path a particular communication is sent between a pair of GPUs; and
implementing, by the device, enforcement of the network policy in the network.

2. The method as in claim 1, wherein implementing enforcement of the network policy in the network comprises:
providing the network policy to one or more leaf nodes in the network.

3. The method as in claim 1, wherein the topology information includes data indicative of communication pathways offloaded to NVLink.

4. The method as in claim 1, wherein the topology information includes data indicative of communication pathways that use a backend network fabric.

5. The method as in claim 1, further comprising:
adjusting, by the device, the network policy based on real-time monitoring data regarding traffic in the network.

6. The method as in claim 1, wherein the network policy uses segment routing to load balance traffic in the network between GPUs.

7. The method as in claim 6, wherein the network policy comprises multiple, disjoint micro segment identifier (uSID) lists.

8. The method as in claim 7, wherein a top of rack (TOR) steers traffic between a particular pair of GPUs in the network using a uSID list associated with that particular pair of GPUs.

9. The method as in claim 7, wherein a network interface card (NIC) steers traffic between a particular pair of GPUs in the network using a uSID list associated with that particular pair of GPUs.

10. The method as in claim 1, wherein the one or more scheduled jobs are training jobs for an artificial intelligence model.

11. An apparatus, comprising:
one or more network interfaces;
a processor coupled to the one or more network interfaces and configured to execute one or more processes; and
a memory configured to store a process that is executable by the processor, the process when executed configured to:
obtain topology information regarding communication pathways available between graphics processing units (GPUs) in a network;
obtain, via an NVIDIA Collective Communications Library (NCCL) application programming interface (API), data indicative of a communication graph of communications between the graphics processing units during one or more scheduled jobs;
compute, based on the communication graph and the topology information, a network policy for the network that controls over which path a particular communication is sent between a pair of GPUs; and
implement enforcement of the network policy in the network.

12. The apparatus as in claim 11, wherein the apparatus implements enforcement of the network policy in the network by:
providing the network policy to one or more leaf nodes in the network.

13. The apparatus as in claim 11, wherein the topology information includes data indicative of communication pathways offloaded to NVLink.

14. The apparatus as in claim 11, wherein the topology information includes data indicative of communication pathways that use a backend network fabric.

15. The apparatus as in claim 11, wherein the process when executed is further configured to:
adjust the network policy based on real-time monitoring data regarding traffic in the network.

16. The apparatus as in claim 11, wherein the network policy uses segment routing to load balance traffic in the network between GPUs.

17. The apparatus as in claim 16, wherein the network policy comprises multiple, disjoint micro segment identifier (uSID) lists.

18. The apparatus as in claim 17, wherein a top of rack (TOR) steers traffic between a particular pair of GPUs in the network using a uSID list associated with that particular pair of GPUs.

19. The apparatus as in claim 17, wherein a network interface card (NIC) steers traffic between a particular pair of GPUs in the network using a uSID list associated with that particular pair of GPUs.

20. A tangible, non-transitory, computer-readable medium storing program instructions that cause a device to execute a process comprising:
obtaining, by the device, topology information regarding communication pathways available between graphics processing units (GPUs) in a network;
obtaining, by the device and via an NVIDIA Collective Communications Library (NCCL) application programming interface (API), data indicative of a communication graph of communications between the graphics processing units during one or more scheduled jobs;
computing, by the device and based on the communication graph and the topology information, a network policy for the network that controls over which path a particular communication is sent between a pair of GPUs; and
implementing, by the device, enforcement of the network policy in the network.
